(19) United States
(12) Patent Application Publication
(10) Pub. No.: US 2015/0125776 A1
(43) Pub. Date: May 7, 2015

(54) FUEL CELL STACK AND A METHOD OF ASSEMBLING A FUEL CELL STACK

(71) Applicant: Intelligent Energy Limited, Loughborough (GB)

(72) Inventor: Peter David Hood, Loughborough (GB)

(21) Appl. No.: 14/399,150

(22) PCT Filed: May 24, 2013
(86) PCT No.: PCT/GB2013/051380

§ 371 Date: Nov. 5, 2014

(30) Foreign Application Priority Data
May 28, 2012 (GB) 1209395.1

(51) Int. Cl. H01M 8/24; H01M 8/00

(52) U.S. Cl. CPC H01M 8/2465; H01M 8/00
USPC 429/456; 429/535

(57) ABSTRACT

A fuel cell stack (100) comprising a plurality of fuel cell assemblies (102) adjacent to one another. The fuel cell assemblies each comprise an extended portion (104, 106, 108) having an aperture (110, 112, 114) therein. The aperture (110, 112, 114) is configured to provide a fluid connection to a fluid flow channel of the fuel cell assembly (102). The fuel cell stack (100) also comprises a clip (120, 122, 124) located over and around at least part of the extended portions (104, 106, 108) of the plurality of the fuel cell assemblies (102). The clip (120, 122, 124) is configured to resist outward expansion of the extended portions (104, 106, 108).

This patent application claims priority to International Patent Application PCT/GB2013/051380 filed on May 24, 2013, which claims priority to United Kingdom Patent Application 1209395.1 filed on May 28, 2012, the contents of which are incorporated here in their entirety.

The present disclosure relates to the field of fuel cell stacks and methods of assembling fuel cell stacks.

Conventional electrochemical fuel cells convert fuel and oxidant, generally both in the form of gaseous streams, into electrical energy and a reaction product. A common type of electrochemical fuel cell for reacting hydrogen and oxygen comprises a polymeric ion (proton) transfer membrane, with fuel and air being passed over respective sides of the membrane. Protons (i.e. hydrogen ions) are conducted through the membrane, balanced by electrons conducted through a circuit connecting the anode and cathode of the fuel cell. To increase the available voltage, a stack may be formed comprising a number of such membranes arranged with separate anode and cathode fluid flow paths. Such a stack is typically in the form of a block comprising numerous individual fuel cell plates held together by end plates at either end of the stack.

According to a first aspect of the invention, there is provided a fuel cell stack comprising:
a plurality of fuel cell assemblies adjacent to one another, the fuel cell assemblies each comprising an extended portion having an aperture therein, the aperture configured to provide a fluid connection to a fluid flow channel of the fuel cell assembly; and
a clip located over and around at least part of the extended portions of the plurality of fuel cell assemblies, wherein the clip is configured to resist outward expansion of the extended portions.

Use of such a clip can maintain the shape of the aperture within the extended portion, thereby maintaining the geometric integrity of the aperture, particularly when operating the fuel cell stack with high pressure fluids. In this way, any degradation in performance that would occur if the aperture were deformed can be reduced. In addition, the volume of material can be required for the extended portions may be reduced due to the structural support provided by the clip. Such a reduction in material can provide a more economical and easier to construct fuel cell stack.

The clip may be referred to as a support clip and may be rigid.

The extended portion may be made from a deformable material, such as rubber or plastic. The extended portion may be made entirely from a deformable material. It may not be necessary to provide internal reinforcement for the extended portion.

The apertures in the plurality of fuel cell assemblies may together define a fluid communication conduit through the fuel cell assemblies. The apertures in the plurality of fuel cell assemblies may together define a fluid communication conduit to the fluid flow channels of the fuel cell assemblies.

The width of the extended portion may be defined as a function of distance from an end surface of the fuel cell assembly from which it extends, or alternatively as a function of distance from a distal end of the extended portion. The extended portion may have a neck portion and a retaining portion. The neck portion may be closer to the end surface of the fuel cell assembly from which it extends than the retaining portion. The retaining portion may be closer to a distal end of the extending portion than the neck portion. The retaining portion may be wider than the neck portion.

Providing the neck portion and retaining portion can enable the clip to self-latch onto the extended portion. That is, the clip may be become more firmly engaged with the extended portion as the pressure within the aperture increases.

The extended portion may be triangular or frusto-triangular. The clip may be configured to engage with three sides of the triangular or frusto-triangular extended portions.

The clip may comprise three internal surfaces:
an end surface that is in the vicinity of a distal end of the extended portion;
a first side surface that extends from the end surface of the clip, past a first side of the retaining portion of the extended portion towards a first side of the neck portion of the extended portion; and
a second side surface that extends from the end surface of the clip, past a second side of the retaining portion of the extended portion towards a second side of the neck portion of the extended portion.

One or both of the first side surface and the second side surface of the clip may comprise a barb configured to engage with the extended portion in order to obstruct removal of the clip from the extended portion. Such a barb or barbs can further improve the engagement with the extended portion.

The barb may be configured to engage with the extended portion when a pressurised fluid is present in the aperture within the extended portion.

According to a further aspect of the invention, there is provided a method of assembling a fuel cell stack, the method comprising:
aligning a plurality of fuel cell assemblies to form a fuel cell stack, the fuel cell assemblies each comprising an extended portion having an aperture therein for providing a fluid connection to a fluid flow channel of the fuel cell assembly; and
fitting a clip over and around at least a portion of the extended portions of one or more of the fuel cell assemblies.

The clip may resist outward expansion of the extended portion, which may be generated when a pressurised fluid is provided in the apertures/ports of the fuel cell assemblies, for example.

Fitting the clip may comprise deforming the clip and locating the deformed clip over at least a part of the extended portions of the fuel cell assemblies. Fitting the clip may comprise deforming the extended portions and locating the clip over at least a part of the deformed extended portions of the fuel cell assemblies. Fitting the clip may comprise sliding the clip over at least a part of the extended portions of the fuel cell assemblies.

A description is now given, by way of example only, with reference to the accompanying drawings, in which:

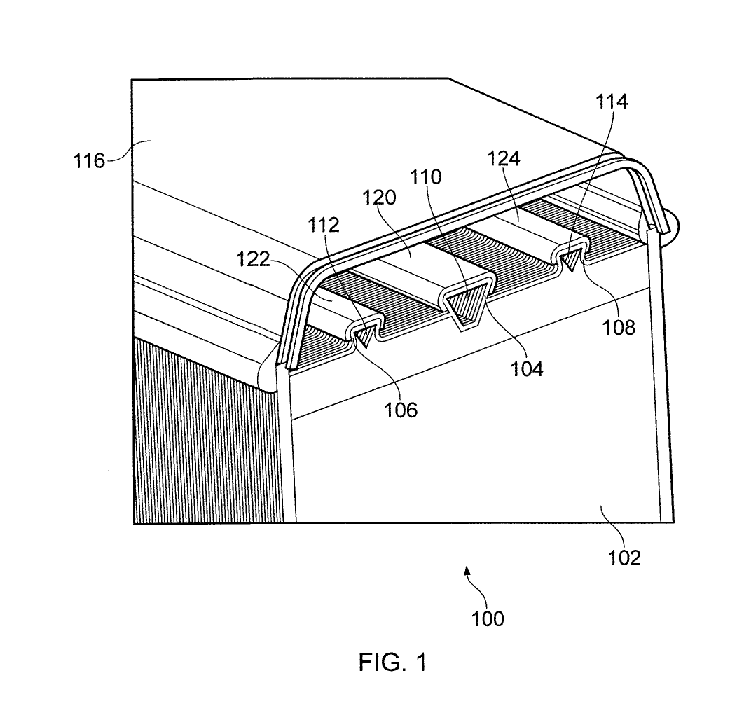

FIG. 1 shows a part of a fuel cell stack according to an embodiment of the invention;

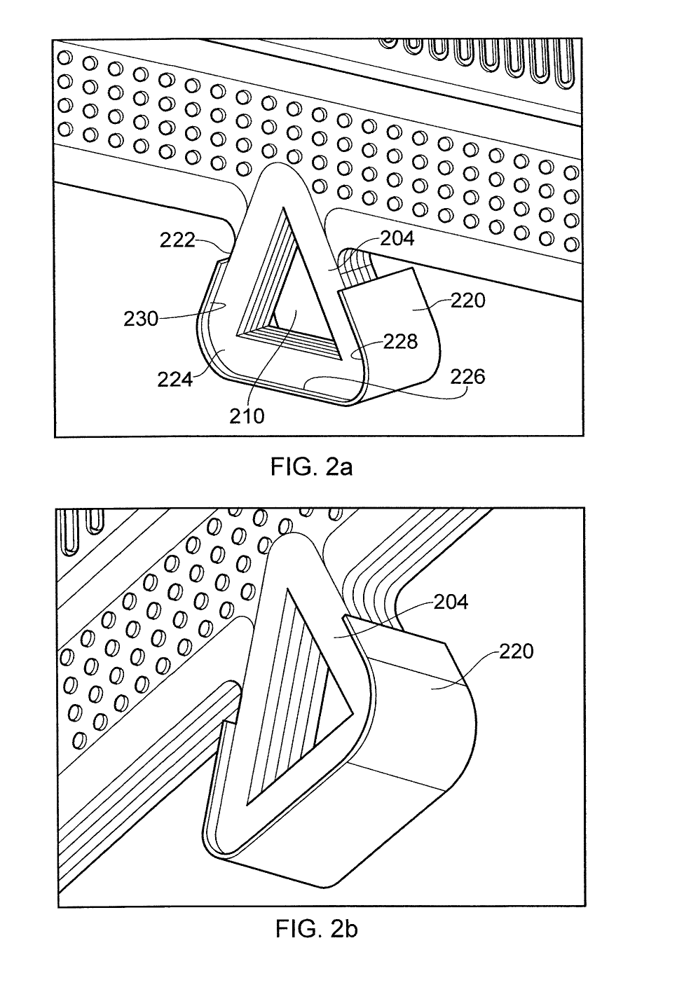

FIGS. 2a and 2b illustrate an extended portion of a fuel cell assembly with a clip according to an embodiment of the invention;

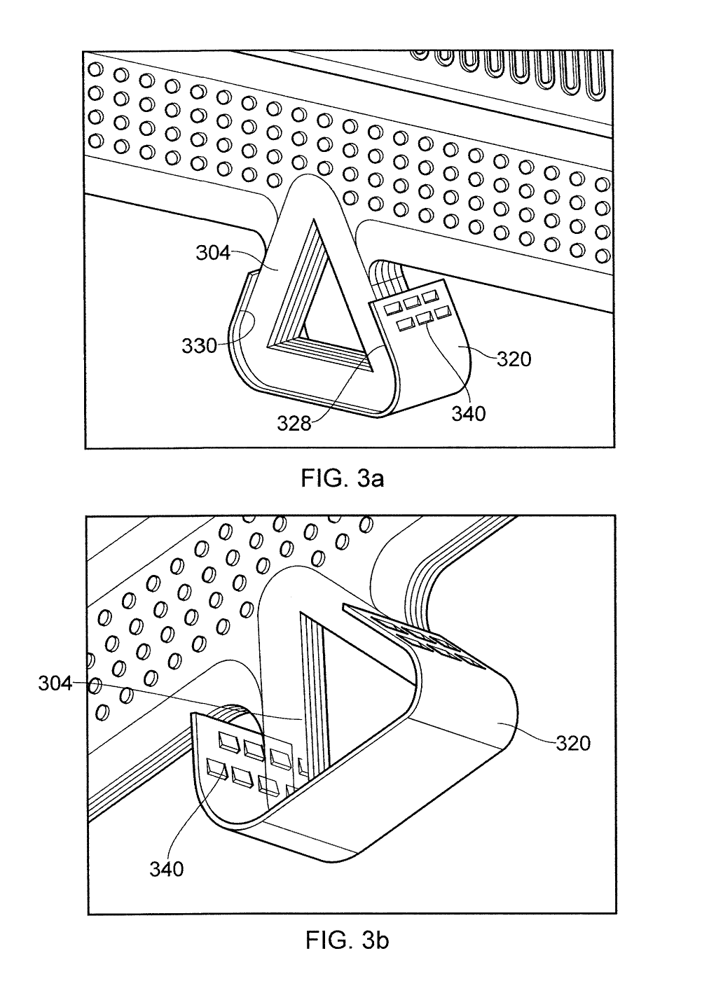

FIGS. 3a and 3b illustrate a clip according to another embodiment of the invention; and

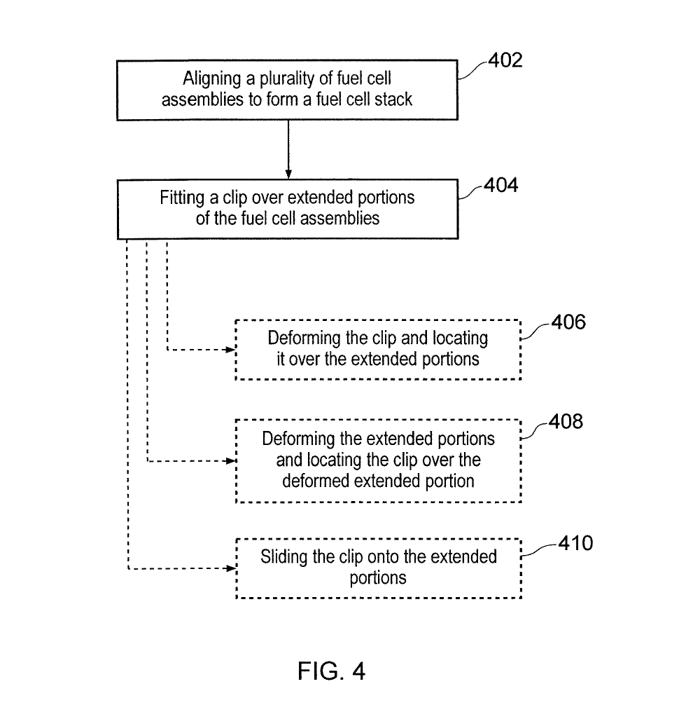

FIG. 4 illustrates schematically a process flow for assembling a fuel cell stack according to an embodiment of the invention.

One or more embodiments disclosed herein relate to a fuel cell stack comprising a plurality of fuel cell assemblies. The fuel cell assemblies each have an extended portion with an aperture therein. The apertures of the fuel cell assemblies together define a conduit for providing a fluid to fluid flow channels of the fuel cell assemblies. The fluid may be hydrogen fuel, water, coolant, or an oxidant, for example. The fuel cell stack may comprise a clip located over the extended portions of the fuel cell assemblies in order to structurally support the extended portion, and therefore maintain the shape of the aperture in the extended portion. Use of such a clip can reduce the likelihood that the performance of the fuel cell stack is degraded through distortion of the aperture when operating at elevated pressures. Elevated pressures may be considered to be elevated with respect to the ambient pressure outside the aperture (that is, outside the fuel cell stack and its operating apertures and channels).

FIG. 1 shows a part of a fuel cell stack 100 according to an embodiment of the invention. The fuel cell stack 100 comprises a plurality of fuel cell assemblies 102 that are adjacent to one another to form the stack, as is known in the art. Typically, an end plate (not shown) is provided at each end of the fuel cell stack.

In this example, each of the fuel cell assemblies 102 includes: a first extended portion 104 with an aperture 110 therein; a second extended portion 106 with an aperture 112 therein; and a third extended portion 108 with an aperture 114 therein. When the fuel cell stack 100 is assembled, in this example, the first apertures 110 in each of the fuel cell assemblies 102 define a conduit for providing water to each of the fuel cell assemblies 102 in the fuel cell stack 100. In this example the second and third apertures 112, 114 define conduits for providing fuel to the anodes of each of the fuel cell assemblies 102 in the fuel cell stack 100 in this example. The apertures 110, 112, 114 may also be referred to as ports. The apertures 110, 112, 114 are in fluid communication with fluid flow channels of the associated fuel cell assemblies 102.

It will be appreciated that any number of extended portions and apertures can be provided in accordance with the requirements of the fuel cell stack 100, for example how the fuel cell stack 100 is to be cooled. Also, the apertures can define inlet or exhaust conduits.

In this example, the extended portions 104, 106, 108 are provided in an overmoulding component made from a deformable material such as rubber. When the fuel cell assemblies 102 are compressed together to form a fuel cell stack 100, the extended portions 104, 106, 108 are restricted to being deformable in the plane of the fuel cell assembly 102.

If fluids with high operating pressures are provided through the conduits defined by the apertures 110, 112, 114, then the extended portions 104, 106, 108 can in some cases become geometrically unstable. In some examples, any geometric deformation of the extended portions can degrade the performance of the fuel cell stack. It has been found that internal reinforcement (for example using insert moulding) can be expensive and complex to manufacture.

According to this embodiment, a clip 120, 122, 124 is located over and around at least part of each of the extended portions 104, 106, 108. A first clip 120 is located over and around the first extended portion 104, a second clip 122 is located over and around the second extended portion 106, and a third clip 124 is located over and around the third extended portion 108. A single clip 120, 122, 124 can extend along the length of the fuel cell stack 100. Alternatively, multiple clips 120, 122, 124 can be provided in a series along the length of the fuel cell stack. That is, each clip 120, 122, 124 can be located over and around a subset of the extended portions 104, 106, 108 of the fuel cell assemblies 102.

The clips 120, 122, 124 resist outward expansion of their associated extended portions 104, 106, 108, which might otherwise occur when pressurized fluids are passed through the apertures 110, 112, 114. The clips 120, 122, 124 can be made from metal or hard plastic, or any other material that can sufficiently resist deformation at the forces that are likely be applied by the pressurised extended portion 104, 106, 108. The clips 120, 122, 124 provide a robust, simple, cost effective and adaptable means for enabling high/elevated pressure operation of the fuel cell stack 100, whilst still being convenient for mass manufacture and fuel cell stack assembly. An elevated pressure may be considered to be a pressure above 1 bar gauge (0.1 MPa).

In some examples, the clips 120, 122, 124 can project into, and be retained in position by, one or both end plate components (not shown) for added geometric security of the extended portions 104, 106, 108.

In this example an air box 116 is shown positioned over the top edges of the fuel cell assemblies 102 in order to define an enclosed space for providing air to the fuel cell assemblies 102.

FIGS. 2a and 2b illustrate an extended portion 204 of a fuel cell assembly with a clip 220 according to an embodiment of the invention. The width of the extended portion 204 is defined as a function of distance from an end surface of the fuel cell assembly from which it extends. The width of the extended portion 204 increases as the extended portion 204 extends away from the fuel cell assembly. In this example, the extended portion 204 is generally triangular, or frusto-triangular, with the widest part of the triangle furthest from the centre of the fuel cell assembly. In this way, the extended portion 204 has a neck portion 222 that has a smaller width than a retaining portion 224 of the extended portion 204. The retaining portion 224 is closer to a distal end of the extended portion 204 than the neck portion 222. The aperture 210 in this example is similarly triangular in shape.

Use of a triangular aperture 210 can allow for efficient use of the internal surfaces of the extended portion 204 for port edges. That is, a large number of access ports to the fluid flow channel can be provided in the relatively large surface area of the internal surfaces of the extended portion 204. The access ports are for communicating a fluid between the conduit that is defined by the apertures 210 and the fluid flow channels in the plurality of fuel cell assemblies. This relatively large surface area can reduce the pressure drop or back pressure experienced by a fluid as it enters a fluid flow channel from the aperture 210.

In other examples, the extended portion and/or apertures may have a frusto-circular shape. The extended portion in particular may define a neck portion closer to the end surface of the fuel cell assembly, and define a retaining portion closer to a distal end of the extending portion than the neck portion. The extended portion may be frusto-circular and define a circumference over a greater than 180° degree range (that is, greater than a semicircular shape). The retaining portion may have a diameter for example the diameter of the (frusto-) circle.

The clip comprises three main internal surfaces:
an end surface 226 that is in the vicinity of the distal end of the extended portion 204;
a first side surface 228 that extends from the end surface 226 of the clip 220, past a first side of the retaining portion 224 of the extended portion 204 towards a first side of the neck portion 222 of the extended portion 204; and
a second side surface 230 that extends from the end surface 226 of the clip 220, past a second side of the retaining portion 224 of the extended portion 204 towards a second side of the neck portion 222 of the extended portion 204.

The first and second side surfaces 228, 230 of the clip 220 need not necessarily extend as far as the thinnest part of the neck portion 222. The two side surfaces 228, 230 of the clip 220 can be considered as extending away and inwards from the end surface 226 of the clip 220.

The reduced width of the neck portion 222 compared with the retaining portion 224 assists with the retention of the clip 220 over the extended portion 204. That is, as the pressure of a fluid within the aperture 210 increases, a force is exerted on the internal surfaces of the extended portion 204. This causes the outer surfaces of the extended portion 204 to exert a force on the three internal surfaces 226, 228, 230 of the clip 220, thus drawing the clip 220 firmly into place and securing the geometry of the port that is defined by the aperture 210. As the pressure inside the port rises, the angled first and second side surfaces 228, 230 of the clip 220 are driven up/pushed towards the external angled surfaces, towards the fuel cell stack, of the extended portion 204, thereby increasing the force applied by the clip's end surface 226 to the distal end of the extended portion 204. This increase in force further secures the geometry of the port/aperture 210. Such a clip 220 can be considered as self-latching.

Furthermore, use of the clip 220 can enable a reduced amount of material to be required for the extended portion 204. For example, the volume of material that is required for the extended portion 204 can be reduced by up to approximately 75% around the apertures 210 when a clip 220 is used. This represents a significant cost saving by requiring less material to form the aperture/extended portion section of the fuel cell assembly.

In some embodiments, the relative dimensions of the neck portion 222 and the retaining portion 224 may only exist, or may be exaggerated, when a force is applied from within the aperture 210 of the extended portion. For example, the retaining portion 224 may be less stiff than the neck portion 222 such that the width of the retaining portion 224 is increased by a greater degree than the width of the neck portion 222 when a high-pressurised fluid is present in the aperture 210. In such examples, the clip 220 may or may not abut the retaining portion 224 when the aperture 210 is not sufficiently (highly) pressurised. The clip 220 may abut the retaining portion 224 when the aperture 210 is at a working (high) pressure.

The difference in stiffness along the extended portion 204 can be provided by: using different materials for the neck portion 222 and the retaining portion 224 and/or using different thicknesses of material at the neck and retaining portions 222, 224 (wherein the thickness dimension is taken to be in the plane of the fuel cell assembly), for example.

The retaining portion 224 and neck portion 222 should not be so mobile/flexible under pressure that electrode assemblies (not shown) located between the moulded apertures in the fuel cell stack assembly would be placed under stress (that is, stress which may cause the electrode assemblies to be damaged or which would prevent normal operation).

FIGS. 3a and 3b illustrate a clip 320 according to another embodiment of the invention. In this example, the side surfaces 328, 330 of the clip 320, which engage with the extended portion 304, comprise barbs 340 (or may comprise any other obstruction to the removal of the clip 320 from the extended portion 304). Such barbs 340 can be particularly advantageous for embodiments where there is no neck portion (that is, where the profile of the extended portion is rectangular/square, for example).

FIG. 4 illustrates schematically a process flow for assembling a fuel cell stack according to an embodiment of the invention. The process flow can be performed manually and/or automatically.

The process flow begins at step 402 by aligning a plurality of fuel cell assemblies to form a fuel cell stack. The fuel cell assemblies comprise an extended portion having an aperture therein for providing a fluid connection to a fluid flow channel of the fuel cell assembly.

At step 404, a clip is fitted over and around at least a portion of the extended portions of one or more of the fuel cell assemblies. The clip can resist outward expansion of the extended portion, which may be generated when a pressurised fluid is provided in the apertures/ports of the fuel cell assemblies, for example.

The clip can be fitted at step 404 in any of a number of ways. Three non-limiting examples are illustrated as steps 406, 408, 410. Any one or more of steps 406, 408, 410 may be performed.

At step 406, the clip is deformed. For example it may be sprung apart, and then located over at least a portion of the extended portions of the fuel cell assemblies. The clip can then be allowed to recover its original shape thereby engaging the clip with the extended portion.

At step 408, the extended portions are deformed. For example they may be partially collapsed. The clip is then located over the deformed extended portions. The extended portion can be deformed mechanically, or by applying a vacuum to the fuel cell stack assembly, for example. Such deformation should be minimal and carefully performed, for example to minimise stresses on electrode assemblies (not shown) located between the fuel cell assemblies.

At step 410, the clip is slid over the extended portions. It will be appreciated that the clip could be moved relative to the fuel cell stack or vice versa. Step 410 may not be possible in examples where an end plate of the fuel cell stack obscures the extended portions of the first and last fuel cell assemblies in the fuel cell stack.

1. A fuel cell stack comprising:
a plurality of fuel cell assemblies adjacent to one another, the fuel cell assemblies each comprising an extended portion having an aperture therein, the aperture configured to provide a fluid connection to a fluid flow channel of the fuel cell assembly; and
a clip located over and around at least part of the extended portions of the plurality of the fuel cell assemblies, wherein the clip is configured to resist outward expansion of the extended portions.

2. The fuel cell stack of claim 1, wherein the extended portion is made from a deformable material.

3. The fuel cell stack of claim 1, wherein the apertures in the plurality of fuel cell assemblies together define a fluid communication conduit through the fuel cell assemblies.

4. The fuel cell stack of claim 1, wherein the width of the extended portion is defined as a function of distance from an end surface of the fuel cell assembly from which it extends.

5. The fuel cell stack of claim 4, wherein the extended portion has a neck portion and a retaining portion, wherein the neck portion is closer to the end surface of the fuel cell assembly from which it extends than the retaining portion and the retaining portion is wider than the neck portion.

6. The fuel cell stack of claim 5, wherein the extended portion is triangular or frusto-triangular, and the clip is configured to engage with three sides of the triangular or frusto-triangular extended portions.

7. The fuel cell stack of claim 5, wherein the clip comprises three internal surfaces:
an end surface that is in the vicinity of a distal end of the extended portion;
a first side surface that extends from the end surface of the clip, past a first side of the retaining portion of the extended portion towards a first side of the neck portion of the extended portion; and
a second side surface that extends from the end surface of the clip, past a second side of the retaining portion of the extended portion towards a second side of the neck portion of the extended portion.

8. The fuel cell stack of claim 7, wherein one or both of the first side surface and the second side surface of the clip comprises a barb configured to engage with the extended portion in order to obstruct removal of the clip from the extended portion.

9. The fuel cell stack of claim 8, wherein the barb is configured to engage with the extended portion when a pressurised fluid is present in the aperture within the extended portion.

10. A method of assembling a fuel cell stack, the method comprising:
aligning a plurality of fuel cell assemblies to form a fuel cell stack, the fuel cell assemblies each comprising an extended portion having an aperture therein for providing a fluid connection to a fluid flow channel of the fuel cell assembly; and
fitting a clip over and around at least a part of the extended portions of one or more of the fuel cell assemblies.

11. The method of claim 10, wherein fitting the clip comprises deforming the clip and locating the deformed clip over at least a part of the extended portions of the fuel cell assemblies.

12. The method of claim 10, wherein fitting the clip comprises sliding the clip over at least a part of the extended portions of the fuel cell assemblies.

13. (canceled)

14. (canceled)
